(19) United States
(12) Patent Application Publication
(10) Pub. No.: US 2010/0067911 A1
(43) Pub. Date: Mar. 18, 2010

(54) INJECTION LIGHT GENERATOR FOR USE IN WAVELENGTH DIVISION MULTIPLEXED-PASSIVE OPTICAL NETWORK

(75) Inventors: Jae Oh Byun, Chungcheongnam-do (KR); Kyoung Min Kim, Seoul (KR)

Correspondence Address: LERNER, DAVID, LITTENBERG,;KRUMHOLZ & MENTLIK, 600 SOUTH AVENUE WEST, WESTFIELD, NJ, 07090, US

(73) Assignee: LUXPERT TECHNOLOGIES CO., LTD., Gwangju (KR)

(21) Appl. No.: 12/516,886

(22) PCT Filed: Dec. 13, 2007
(86) PCT No.: PCT/KR07/06510

§ 371 Date: May 29, 2009

(30) Foreign Application Priority Data
Oct. 4, 2007 (KR) 10-2007-0099731

(51) Int. Cl. H04J 14/00

(52) U.S. Cl. 398/68

(57) ABSTRACT

The invention is related to an injection light generator for use in a wavelength division multiplexed-passive optical network, which generates A-band injection light having a spectrum range separated into N wavelength ranges (N is a natural number equal to or greater than 2) to be used for a transmission of a downstream optical signal and B-band injection light having a spectrum range separated into N wavelength ranges to be used for a transmission of an upstream optical signal.

### TECHNICAL FIELD

The present invention relates to an injection light generator for use in a WDM-PON(wavelength division multiplexed-passive optical network); and, more particularly, to an injection light generator for use in a WDM-PON, which generates injection light having a spectrum range separated into N wavelength ranges to be used for the transmission of upstream/downstream optical signals.

### BACKGROUND ART

A wavelength division multiplexed-passive optical network (WDM-PON) provides a high speed broadband communication service by using an inherent wavelength assigned to each subscriber. Accordingly, each subscriber receives a signal having a different wavelength corresponding thereto, so that a security is enhanced and a separate communication service is provided to each subscriber, thereby enlarging a communication capacity.

Conventionally, a method has been proposed wherein a central office and a subscriber terminal have a respective light source including a distributed feedback-laser diode (DFB-LD) element, thereby realizing the WDM-PON.

However, such method has some problems such that the cost of DFB-LD element is expensive and requires complicated temperature control technique, which make it difficult to commercialize.

Accordingly, a technique using a wavelength-locked optical signal has been widely employed by injecting an incoherent light source into a low cost Fabry-Perot Laser Diode (FP-LD), thereby implementing an injection-locked WDM optical signal.

Hereinafter, a configuration of a conventional wavelength division multiplexed-passive optical network 100 will be described in reference to FIG. 1. FIG. 1 shows a schematic block diagram for showing a conventional bidirectional communication in an injection-locked wavelength division multiplexed-passive optical network.

The injection-locked wavelength division multiplexed-passive optical network 100 includes a central office 110, a subscriber terminal 130, a remote node 120 for connecting the central office 110 with each subscriber terminal 130 and an optical cable 140.

The central office 110 has an A band injection light source 111, a B band injection light source 112, a light source distributor 113, a first 1×N optical multiplexer/demultiplexer 114 and a multiplicity of transceivers 115.

The remote node 120 has a second 1×N optical multiplexer/demultiplexer 121 and the subscriber terminal 130 has a plurality of transceivers 131.

The A band injection light source 111 is provided as a light source for an A band optical signal serving as a downstream optical signal. As the A band injection light source 111, an incoherent light source may be mainly used. The A band injection light source 111 generates the A band injection optical signal, and then transmits it to the light source distributor 113.

The B band injection light source 112 is provided as a light source for B band optical signal serving as an upstream optical signal, and, like the A band injection light source 111, an incoherent light source may be mainly used as the B band injection light source 112. The B band injection light source 112 generates the B band injection optical signal, and then transmits it to the light source distributor 113.

The light source distributor 113 receives the A band injection optical signal from the A band injection light source 111 and transmits it to the first 1×N optical multiplexer/demultiplexer 114 of the central office 110. Further, the light source distributor 113 receives a wavelength-locked A band optical signal from the first 1×N optical multiplexer/demultiplexer 114 of the central office 110 and transmits it to the optical cable 140 connected to the remote node 120.

In addition, the light source distributor 113 receives the B band injection optical signal from the B band injection light source 112 and transmits it to the second 1×N optical multiplexer/demultiplexer 121 of the remote node 120 through the optical cable 140. Further, the light source distributor 113 receives a wavelength-locked B band optical signal from the second 1×N optical multiplexer/demultiplexer 121 of the remote node 120 and transmits it to the first 1×N optical multiplexer/demultiplexer 114 of the central office 110.

The first 1×N optical multiplexer/demultiplexer 114 separates the A band optical signal received from the light source distributor 113 according to the wavelength thereof, and then, injects it to each transmitter of the transceivers 115 of the central office 110. For example, as the first 1×N optical multiplexer/demultiplexer 114, an arrayed waveguide grating (AWG) may be used.

As the transmitter of the transceivers 115, the Fabry-Perot Laser Diode (FP-LD) may be used and the transmitter generates the downstream optical signal to be transmitted to each subscriber.

Specifically, if the A band injection optical signal separated based on the wavelength thereof is injected to each transmitter of the transceivers 115, wavelength elements having a wavelength different from that of the injected optical signal are suppressed and wavelength elements having a wavelength equal to that of the injected optical signal is locked, thereby outputting the wavelength-locked A band downstream optical signal.

Each receiver of the transceivers 115 receives a wavelength-locked B band upstream optical signal from the subscriber terminal 130, and then, converts it into an electrical signal. A photo diode (PD) may be used as the receiver of the transceivers 115.

The second 1×N optical multiplexer/demultiplexer 121 of the remote node 120 separates the B band optical signal received from the light source distributor 113 based on the wavelength thereof, and then, injects it to the transceivers 131 of the subscriber terminal 130. The arrayed waveguide grating (AWG) may be used as the second 1×N optical multiplexer/demultiplexer 121 similar to the first 1×N optical multiplexer/demultiplexer 114.

Possibly the Fabry-Perot Laser Diode (FP-LD) may be used as the transmitter of the transceivers 131 and the transmitter generates an upstream optical signal to be transmitted to the central office 110.

Specifically, if the B band injection optical signal separated according to the wavelength thereof is injected to the transmitter of the transceivers 131, wavelength elements having a different wavelength from that of the injected optical signal are suppressed and wavelength elements having a wavelength equal to that of the injected optical signal is locked, thereby outputting the wavelength-locked B band upstream optical signal.

Each receiver of the transceivers 131 receives the wavelength-locked A band downstream optical signal from the central office 110, and then, converts it into an electrical signal. A photo diode (PD) may be used as the receiver of the transceivers 131.

FIG. 2 is a diagram illustrating an exemplary spectrum range of a conventional injection light source and upstream/downstream optical signals.

As shown in FIG. 2, the conventional injection light source for use in a wavelength division multiplexed-passive optical network (WDM-PON) generates injection light corresponding to the entire spectrum range of an A band to be used as downstream optical signals and a B band to be used as upstream optical signals. However, it is not the entire spectrum range of the A-band or the B-band injection light that is actually used as an upstream or downstream optical signal, but only the spectrum range outputted by an optical multiplexer/demultiplexer of a central office (CO) is used as the upstream or downstream optical signal.

As shown in FIG. 2, the wavelength range of the injection light source actually used as the upstream/downstream optical signals occupies only about 50% or less of the entire output range thereof. In view thereof, since an unnecessary wavelength range remains unused, the efficiency of the injection light source is considerably low.

Further, with regard to the injection light source for use in the WDM-PON, its price rises in proportion to the increase of the number of subscribers, and a large physical space is required for the installation thereof, resulting in a price rise of the entire system. Moreover, since heat generation increases in proportion to the enhancement of an optical power outputted from the injection light source, a thermal characteristics of the entire system deteriorates, and therefore a temperature control function is additionally required for the control thereof.

Accordingly, as for the injection light source for use in the WDM-PON, there has been a strong demand to develop a technique capable of outputting only the injection light corresponding to the spectrum range to be actually used, without outputting injection light having the unused spectrum range.

### DISCLOSURE OF INVENTION

### Technical Problem

In one implementation, there is provided an injection light generator for use in a wavelength division multiplexed-passive optical network, which generates an A-band injection light and a B-band injection light having a spectrum range separated into N wavelength ranges to be actually used for the transmission of upstream/downstream optical signals, thereby preventing the injection light generator from outputting injection light having an unnecessary wavelength range.

In another implementation, there is provided an injection light generator for use in a wavelength division multiplexed-passive optical network, which is capable of increasing the number of transmission channels efficiently by way of outputting the injection light having only the spectrum range to be actually used.

### Technical Solution

In accordance with one aspect of the invention, there is provided an injection light generator for use in a wavelength division multiplexed-passive optical network, which generates A-band injection light having a spectrum range separated into N wavelength ranges (N is a natural number equal to or greater than 2) to be used for a transmission of a downstream optical signal and B-band injection light having a spectrum range separated into N wavelengths to be used for a transmission of an upstream optical signal.

The injection light generator amplifies powers of the A-band injection light and the B-band injection light, and splits the amplified powers of the A-band and B-band injection light, and transmits the power-split injection light to a plurality of light source distributors.

In accordance with another aspect of the invention, there is provided an injection light generator for use in a WDM-PON, including an injection light source for generating injection light to be injected to an optical transmitter; an optical multiplexer/demultiplexer for separating the injection light into N (N is a natural number greater than or equal to 2) wavelengths corresponding to respective wavelength ranges to be used for a transmission of an optical signal; an optical amplifier for amplifying a power of the injection light separated into the N wavelengths; and an optical splitter for splitting the amplified power of the injection light and transmitting the power-split light through M (M is a natural number greater than or equal to 1) output terminals.

The injection light generator further includes reflection minors respectively connected to N output terminals of the optical multiplexer/demultiplexer, for reflecting the injection light separated into the N wavelengths by the optical multiplexer/demultiplexer and inputted therefrom and transmitting the reflected injection light to the optical amplifiers.

The injection light generator further includes a light source distributor for transmitting the injection light received from the injection light source to the optical multiplexer/demultiplexer and transmitting the injection light separated into the N wavelengths, which has been received from the optical multiplexer/demultiplexer, to the optical amplifier.

The injection light source generates both A-band injection light to be used as a downstream optical signal and B-band injection light to be used as an upstream injection signal.

In accordance with still another aspect of the invention, there is provided an injection light generator for use in a WDM-PON, including a pump diode for generating injection light to be injected to an optical transmitter; an optical multiplexer/demultiplexer for separating the injection light into N (N is a natural number greater than or equal to 2) wavelengths corresponding to respective wavelength ranges to be used for a transmission of an optical signal; an erbium doped fiber for amplifying a power of the injection light separated into the N wavelengths; and an optical splitter for splitting the amplified power of the injection light and transmitting the power-split light through M (M is a natural number greater than or equal to 1) output terminals.

The injection light generator further includes an isolator for transmitting the amplified injection light in a direction toward the optical splitter.

The injection light generator further includes reflection minors respectively connected to N output terminals of the optical multiplexer/demultiplexer, for reflecting the injection light separated into the N wavelengths by the optical multiplexer/demultiplexer and inputted therefrom and transmitting the reflected injection light to the erbium doped fiber.

### BRIEF DESCRIPTION OF THE DRAWINGS

The above features of the present invention will become apparent from the following description of embodiments given in conjunction with the accompanying drawings, in which:

FIG. 1 provides a schematic block diagram for describing conventional bidirectional communication in a WDM-PON;

FIG. 2 sets forth an exemplary diagram for showing a spectrum range of a conventional injection light source and upstream/downstream optical signals;

FIG. 3 presents a schematic block diagram for showing an injection light generator for use in a WDM-PON in accordance with a first embodiment of the present invention;

FIG. 4 depicts a schematic block diagram for showing a configuration of a central office using the injection light generator in accordance with the first embodiment of the present invention; and

FIG. 5 illustrates a schematic block diagram for showing an injection light generator for use in a WDM-PON in accordance with a second embodiment of the present invention.

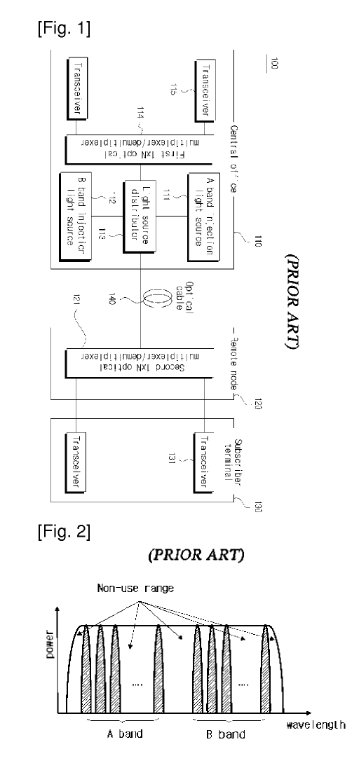

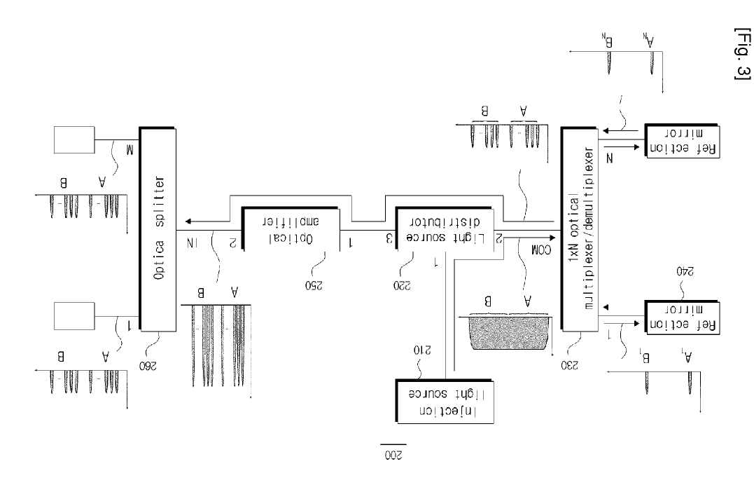

### MODE FOR THE INVENTION

Hereinafter, the embodiments of the present invention will be described with reference to the accompanying drawings which form a part hereof. Further, in this specification and the accompanying drawings, like reference numerals will be given to like parts having substantially same functions, and redundant description thereof will be omitted.

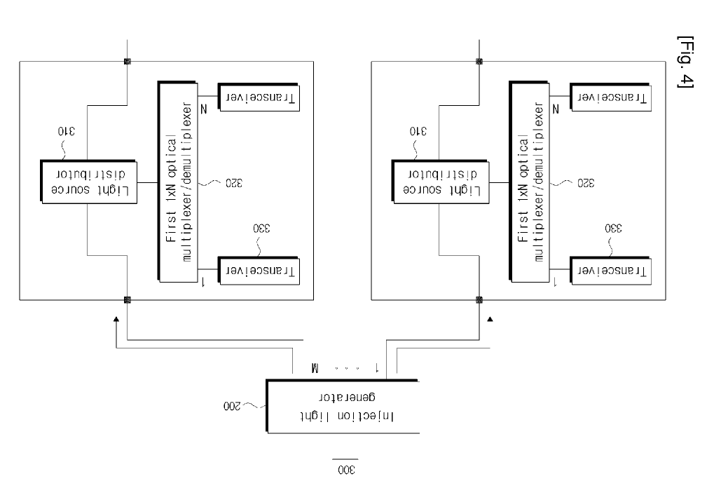

Referring to FIG. 3, a configuration and an operation of an injection light generator 200 for use in a WDM-PON in accordance with a first embodiment of the present invention will be first explained.

The injection light generator 200 includes an injection light source 210, a light source distributor 220, a 1×N optical multiplexer/demultiplexer 230, reflection minors 240, an optical amplifier 250 and an optical splitter 260.

The injection light source 210 generates A-band injection light for a generation of an A-band optical signal serving as a downstream optical signal and B-band injection light for a generation of a B-band optical signal serving as an upstream optical signal, and then transmits them to a first terminal of the light source distributor 220.

The first terminal of the light source distributor 220 is connected to the injection light source 210, while its second and third terminal are coupled to a common (COM) terminal of the 1×N optical multiplexer/demultiplexer 230 and a first terminal of the optical amplifier 250, respectively.

The light source distributor 220 receives the A-band injection light and the B-band injection light from the injection light source 210 through the first terminal, and then transmits them to the 1×N optical multiplexer/demultiplexer 230 which is connected to the light source distributor 220 via the second terminal. Further, the light source distributor 220 receives, through its second terminal, the A-band injection light and the B-band injection light that are reflected from the reflection mirrors 240 installed at one end of each channel after passing through the 1×N optical multiplexer/demultiplexer 230. Then, the light source distributor 220 outputs the reflected A-band and B-band injection light to the third terminal thereof and transmits them to the first terminal of the optical amplifier 250.

The 1×N optical multiplexer/demultiplexer 230 includes the COM terminal and N number of input/output terminals. The COM terminal is connected to the light source distributor 220, and the N input/output terminals are respectively coupled to the N number of reflection mirrors 240.

The 1×N optical multiplexer/demultiplexer 230 receives the A-band injection light and the B-band injection light from the light source distributor 220 and then separates them according to the wavelengths thereof corresponding to respective channels by filtering the received A-band injection light and B-band injection light. Thereafter, the 1×N optical multiplexer/demultiplexer 230 sends the thus-obtained injection light separated by the wavelengths (hereinafter, simply referred to as “wavelength-separated injection light”) to the respective reflection mirrors 240. Here, N is a natural number equal to or greater than 2. Further, the 1×N optical multiplexer/demultiplexer 230 transmits the wavelength-separated A-band and B-band injection light reflected by the reflection minors 240 to the second terminal of the light source distributor 220. As the 1×N optical multiplexer/demultiplexer 230, an arrayed waveguide grating (AWG) may be used, for example.

The first terminal of the optical amplifier 250 is connected to the third terminal of the light source distributor 220, while its second terminal is connected to an input (IN) terminal of the optical splitter 260. The optical amplifier 250 receives the wavelength-separated A-band and B-band injection light from the light source distributor 220 via the first terminal thereof, and then amplifies them. Thereafter, the optical amplifier 250 transmits the amplified injection light to the optical splitter 260 connected to the second terminal thereof.

The optical splitter 260 includes the IN terminal and M number of output terminals (here, M is a natural number no smaller than 1), wherein the IN terminal is connected to the optical amplifier 250 and the M number of output terminals are coupled to respective light source distributors (not shown) of the central office. The optical splitter 260 functions to split an optical power of injection light received by the IN terminal and outputs the thus power-split injection light through its output terminals. Accordingly, the optical splitter 260 receives the wavelength-separated A-band and B-band injection light amplified by the optical amplifier 250 and outputs M number of injection light to the respective light source distributors (not shown) of the central office by splitting their optical powers.

As described, the injection light generator 200 in accordance with the first embodiment of the present invention generates A-band injection light and B-band injection light separated into N wavelengths corresponding to respective wavelength ranges used for the transmission of upstream/downstream optical signals; and then splits the optical power thereof again after amplifying them by using one injection light source 210 which generates both the A-band injection light and the B-band injection light; the light source distributor 220; the 1×N optical multiplexer/demultiplexer 230; the reflection mirrors 240; the optical amplifier 250 and the optical splitter 260. As a result, the injection light generator 200 enables a realization of a WDM-PON featuring a high utilization efficiency of output wavelength range of the injection light source.

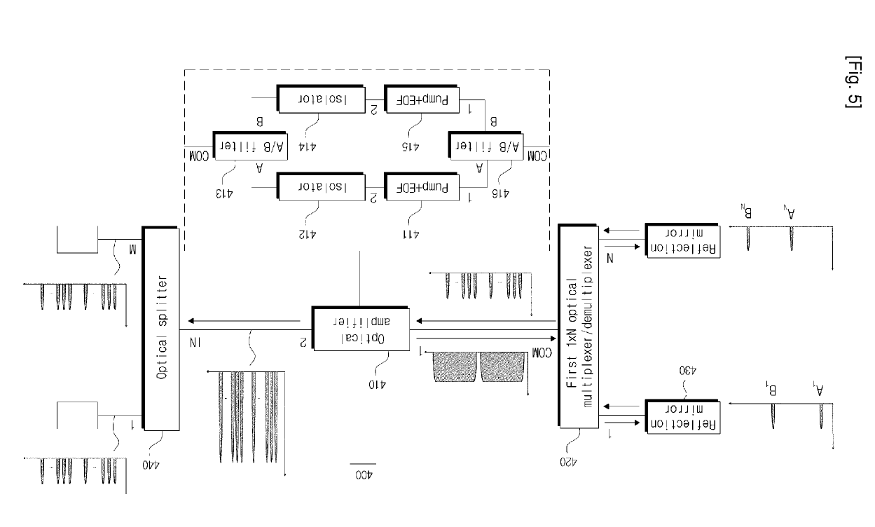

In the following, a configuration of a central office 300 using the injection light generator 200 in accordance with the first embodiment of the present invention will be explained in connection with FIG. 4.

The central office 300 includes the injection light generator 200, light source distributors 310, first 1×N optical multiplexer/demultiplexers 320 and transceivers 330.

The injection light generator 200 generates both A-band injection light and B-band injection light that are wavelength-separated to be used as downstream optical signal and upstream optical signals, respectively. The injection light generator 200 splits the optical powers of the wavelength-separated A-band injection light and B-band injection light and provides the thus power-split injection light to the M number of light source distributors 310 of the central office.

Each light source distributor 310 receives the wavelength-separated A-band injection light and B-band injection light from the injection light generator 200, and then transmits them to corresponding one of the first 1×N optical multiplexer/demultiplexers 320. Further, the light source distributor 310 receives a wavelength-locked A-band optical signal from the first 1×N optical multiplexer/demultiplexer 320 and transmits it to a subscriber terminal (not shown), and it also receives a wavelength-locked B-band optical signal from the subscriber terminal (not shown) and transmits it to the 1×N optical multiplexer/demultiplexer 320.

The 1×N optical multiplexer/demultiplexer 320 separates the A-band optical signal received from the light source distributor 310 by filtering the A-band optical signal according to wavelengths thereof, and then injects them to a transmitter of corresponding one of the transceivers 330.

The transmitter of the transceiver 330 generates downstream signals to be transmitted to respective subscribers.

Specifically, if a wavelength-separated A-band injection light is injected to the transmitter of the transceiver 330, frequency components having a wavelength different from that of the injected light are suppressed, and the frequency components having a wavelength equal to that of the injected light is locked, whereby a wavelength-locked A-band downstream signal is outputted. Further, a receiver of the transceiver 330 receives a wavelength-locked B-band upstream optical signal from a subscriber terminal (not shown) and converts it into an electrical signal.

As described above, the central office 300 in accordance with the embodiment of the present invention splits the optical powers of the A-band injection light separated into N wavelengths and the optical powers of the B-band injection light separated into N wavelengths to thereby output them to the M number of light source distributors. Therefore, it is possible to realize a WDM-PON capable of increasing the number of transmission channels efficiently.

Now, a configuration and an operation of an injection light generator in accordance with a second embodiment of the present invention will be described with reference to FIG. 5, which illustrates an injection light generator 400 for use in a WDM-PON in accordance with the second embodiment.

The injection light generator 400 includes an optical amplifier 410, a 1×N optical multiplexer/demultiplexer 420, reflection minors 430 and an optical splitter 440.

The optical amplifier 410 includes a first pump diode/erbium doped fiber (EDF) 411, a second pump diode/EDF 415, a first and a second isolators 412 and 414, and a first and a second A/B band filter 416 and 413.

Each of the first and the second diode pump/EDF 411 and 415 includes a pumping laser diode and an EDF, wherein the pumping laser diode generates A-band injection light and B-band injection light, and the EDF amplifies the A-band injection light and the B-band injection light generated by the pumping laser diode.

First terminals of the first and the second pump diode/EDF 411 and 415 are connected to a first A/B band filter 416, while second terminals thereof are connected to the first and the second isolator 412 and 414, respectively. The first and the second pump diode/EDF 411 and 415 serve to transmit the A-band injection light and the B-band injection light to the first A/B band filter 416.

The first A/B band filter 416 includes an A terminal, a B terminal and a COM terminal, wherein the A terminal is connected to the first pump diode/EDF 411; the B terminal is connected to the second pump diode/EDF 415; and the COM terminal is connected to a COM terminal of the 1×N optical multiplexer/demultiplexer 420.

The A terminal of the first A/B band filter 416 allows only the A-band injection light among the injection light generated by the first pump diode/EDF 411 to pass therethrough; the B terminal thereof allows only the B-band injection light among the injection light beams generated by the second pump diode/EDF 415 to pass therethrough; and the COM terminal transmits the A-band injection light and the B-band injection light, which have passed through the A terminal and the B terminal respectively, to the 1×N optical multiplexer/demultiplexer 420.

Further, the first A/B band filter 416 receives, through the COM terminal, the A-band injection light and the B-band injection light that are reflected from the reflection mirrors 430 installed at one end of each channel after passing through the 1×N optical multiplexer/demultiplexer 420. Then, the first A/B band filter 416 outputs the received A-band injection light to the A terminal, thereby transmitting it to the first pump diode/EDF 411, whereas it outputs the received B-band injection light to the B terminal, thereby transmitting it to the second pump diode/EDF 415.

The 1×N optical multiplexer/demultiplexer 420 includes a COM terminal and N number of input/output terminals. The COM terminal is connected to the first A/B band filter 416, and the N input/output terminals are respectively coupled to the N number of reflection mirrors 430.

The 1×N optical multiplexer/demultiplexer 420 separates the A-band injection light and the B-band injection light by filtering them according to wavelengths corresponding to the respective channels. Further, the 1×N optical multiplexer/demultiplexer 420 transmits the wavelength-separated A-band and B-band injection light reflected by the reflection minors 430 to the first A/B band filter 416. As the 1×N optical multiplexer/demultiplexer 420, an arrayed waveguide grating (AWG) may be used, for example.

The first isolator 412 allows the A-band injection light amplified by the first pump diode/EDF 411 to pass only in a direction toward the second A/B band, thereby transmitting it to the second A/B band filter 413.

The second isolator 414 also allows the B-band injection light transmitted from the second pump diode/EDF 415 to pass only in a direction toward the second A/B band filter 413, thereby transmitting it to the second A/B band filter 413.

The second A/B band filter 413 includes an A terminal, a B terminal and a COM terminal, wherein the A terminal is connected to the first isolator 412; the B terminal is connected to the second isolator 414; and the COM terminal is connected to an IN terminal of the optical splitter 440.

The second A/B band filter 413 transmits the A-band injection light, which has been received from the first isolator 412 through its A terminal, and the B-band injection light, which has been received from the second isolator 414 through its B terminal, to the optical splitter 440 via the COM terminal thereof.

The optical splitter 440 includes the IN terminal and M number of output terminals, wherein the IN terminal is connected to the second A/B band filter 413 of the optical amplifier 410, and the M number of output terminals are respectively coupled to M number of light source distributors (not shown) of the central office. The optical splitter 440 functions to split an optical power of injection light received by the IN terminal and outputs the thus power-split injection light through its output terminals. Accordingly, the optical splitter 440 receives the wavelength-separated A-band and B-band injection light amplified by the optical amplifier 410 and splits their optical powers into M number of power-split injection light and outputs them to the respective light source distributors (not shown) of the central office.

As described, the injection light generator 400 in accordance with the second embodiment of the present invention generates A-band injection light and B-band injection light separated into N wavelengths corresponding to respective wavelength ranges used for the transmission of upstream/downstream optical signals; and then splits the optical powers thereof again after amplifying them by using the optical amplifier 410, the 1×N optical multiplexer/demultiplexer 420, the reflection minors 430 and the optical splitter 440. As a result, the injection light generator 200 enables a realization of a WDM-PON featuring a high utilization efficiency of output wavelength range of the injection light source.

While the invention has been shown and described with respect to the embodiments, it will be understood by those skilled in the art that various changes and modifications may be made without departing from the scope of the invention as defined in the following claims.

### INDUSTRIAL APPLICABILITY

In accordance with one aspect of the present invention described above, there is provided an injection light generator for use in the WDM-PON, which generates A-band injection light and B-band injection light separated into N wavelengths corresponding to wavelength ranges to be used for the transmission of upstream/downstream optical signals, thus featuring a high utilization efficiency of output wavelength range of an injection light source.

Further, in accordance with another aspect of the present invention, there is provided an injection light generator for use in the WDM-PON, which is capable of increasing the number of transmission channels efficiently by way of branching the A-band injection light and the B-band injection light separated into the N wavelengths to M light source distributors of the central office.

1. An injection light generator for use in a wavelength division multiplexed-passive optical network, which generates A-band injection light having a spectrum range separated into N wavelength ranges (N is a natural number equal to or greater than 2) to be used for a transmission of a downstream optical signal and B-band injection light having a spectrum range separated into N wavelength ranges to be used for a transmission of an upstream optical signal.

2. The injection light generator of claim 1, which amplifies powers of the A-band injection light and the B-band injection light, and splits the amplified powers of the A-band and B-band injection light, and transmits power-split injection light to a plurality of light source distributors.

3. An injection light generator for use in a WDM-PON, comprising:
an injection light source for generating injection light to be injected to an optical transmitter;
an optical multiplexer/demultiplexer for separating the injection light into N (N is a natural number greater than or equal to 2) wavelengths corresponding to respective wavelength ranges to be used for a transmission of an optical signal;
an optical amplifier for amplifying a power of the injection light separated into the N wavelengths; and
an optical splitter for splitting the amplified power of the injection light and transmitting the power-split light through M (M is a natural number greater than or equal to 1) output terminals.

4. The injection light generator of claim 3, further comprising reflection mirrors respectively connected to N output terminals of the optical multiplexer/demultiplexer, for reflecting the injection light separated into the N wavelengths by the optical multiplexer/demultiplexer and inputted therefrom and transmitting the reflected injection light to the optical amplifiers.

5. The injection light generator of claim 3, further comprising a light source distributor for transmitting the injection light received from the injection light source to the optical multiplexer/demultiplexer and transmitting the injection light separated into the N wavelengths, which has been received from the optical multiplexer/demultiplexer, to the optical amplifier.

6. The injection light generator of claim 3, wherein the injection light source generates both A-band injection light to be used as a downstream optical signal and B-band injection light to be used as an upstream injection signal.

7. An injection light generator for use in a WDM-PON, comprising:
a pump diode for generating injection light to be injected to an optical transmitter;
an optical multiplexer/demultiplexer for separating the injection light into N (N is a natural number greater than or equal to 2) wavelengths corresponding to respective wavelength ranges to be used for a transmission of an optical signal;
an erbium doped fiber for amplifying a power of the injection light separated into the N wavelengths; and
an optical splitter for splitting the amplified power of the injection light and transmitting the power-split light through M (M is a natural number greater than or equal to 1) output terminals.

8. The injection light generator of claim 7, further comprising an isolator for transmitting the amplified injection light in a direction toward the optical splitter.

9. The injection light generator of claim 7, further comprising reflection mirrors respectively connected to N output terminals of the optical multiplexer/demultiplexer, for reflecting the injection light separated into the N wavelengths by the optical multiplexer/demultiplexer and inputted therefrom and transmitting the reflected injection light to the erbium doped fiber.
